(19) United States
(12) Patent Application Publication
(10) Pub. No.: US 2022/0335160 A1
(43) Pub. Date: Oct. 20, 2022

(54) SYSTEM AND METHOD FOR THE GENERATION OF PRIVACY-PRESERVING EMBEDDINGS

(71) Applicant: WeWork Companies LLC, New York, NY (US)

(72) Inventors: Kalman Chapman, New York, NY (US); Jason Bryslawskyj, San Diego, CA (US)

(21) Appl. No.: 17/722,676

(22) Filed: Apr. 18, 2022

Related U.S. Application Data
(60) Provisional application No. 63/176,052, filed on Apr. 16, 2021.

(51) Int. Cl. G06F 21/62; G06N 3/08; G06N 3/04

(52) U.S. Cl. CPC G06F 21/6254; G06N 3/088; G06N 3/0481

(57) ABSTRACT

Embodiments are directed towards systems and method for the generation of a privacy-preserving embedding from an arbitrary source image. The system according to one embodiment comprises a plurality of convolutional blocks wherein the output from a first one of the plurality of convolutional blocks is passed to a next one of the plurality of convolutional blocks, a given one of the plurality of convolutional blocks comprising a downsampling convolutional layer, a batch normalization layer, and a nonlinear activation function. The system further comprises a dense neural network layer to receive the output of the plurality of convolutional blocks, the plurality of convolutional blocks and dense neural network layer arranged as an encoder network, wherein the encoder network receives an arbitrary source image and generates the privacy-preserving embedding as a sample from an information dense vector space with patterns that describe semantic information of the arbitrary source image.

### CROSS REFERENCE TO RELATED APPLICATIONS

The present application claims priority to Provisional Patent Application No. 63/176,052, filed Apr. 16, 2021, entitled “SYSTEM AND METHOD FOR THE GENERATION OF PRIVACY-PRESERVING EMBEDDINGS THAT PROVIDE FOR ANALYSIS OF SOURCE IMAGES”, the disclosure of which is hereby incorporated by reference herein in its entirety for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The inventions described herein generally relate to models trained through the use of machine learning. More specifically, inventions disclosed and described herein relate to the use of machine learning to train an encoder to reduce information in a source image (including personally identifiable information (“PII”)) to a lower-dimensional space where retrieval of PII is not possible, while retaining semantic information contained in such source image, as well as uses thereof.

### BACKGROUND OF THE INVENTION

Video surveillance, such as through the use of CCTV systems, has become prolific in a variety of public environments. Similarly, there is an extraordinary number of such cameras used for internal monitoring of private property. Such increased surveillance gives rise to privacy concerns surrounding the storage and analysis of private and other PII contained in the captured video. When dealing with fully digital source video streams, this creates a natural tension: there is a need to perform computer vision analysis of stored images to discern specific information contained therein, but without compromising PII so as to provide analysis of source video in a manner that mitigates privacy concerns.

These concerns are particularly pronounced in real estate where product usage takes place within a physical space and continually evolves over time. Put another way, occupant activity is the primary manner in which product usage is observed and quantified in commercial environments. As such, video surveillance systems in commercial environments are capable of generating millions of images daily, with the use of such images as a “snapshot” of reality having the capacity to contain enormous amounts of information. Compared to other IoT measurement approaches, a single image may contain information that would take dozens of other individual sensors to collect. Due to privacy considerations, however, these images are not being leveraged to provide their full value to the underlying businesses.

Any given image collected by internal video systems used for measuring product usage may present privacy concerns, and simple video manipulation is not sufficient to address these concerns, particularly from a legal standpoint in many jurisdictions. State of the art results show that an image faithfully representing PII can be reconstructed from a 12×14 pixel image with three, 8-bit color channels when using certain deep-learning facial recognition techniques.

Using an information theoretic framework, it can be concluded that state of the art recognition techniques are limited by a lower bound of 4032 informational bits; if these techniques are used with fewer than 4032 informational bits, the ability to faithfully recreate PII degrades rapidly. In the course of considering the nature of digital images, moreover, it can be shown that 4032 informational bits may be kept in fewer physical bits when an effective compression ratio is applied. Considering real-world lossless compression, such as those that could contain 4032 informational bits within fewer than such number of physical bits, compression ratios from 1 to 3.5 can be achieved.

Considering a conservative estimate of a maximum lossless compression ratio C_{R}=3.5 and informational lower bound S_{img}=4032 bits as the smallest possible uncompressed image information that can support facial recognition, an estimate of the lower bound needed to perform facial recognition tasks can be represented as S_{img}/C_{R}=˜1150 bits. By this estimation and others, it can be shown that image representations with fewer than 1150 informational bits may foil the advanced compression and facial recognition techniques that may be used to recreate PII from image representations.

Working on the assumption that for real world images there is a lower bound on the size of images for which facial recognition is possible, an estimate of the lower bound on the information content can be arrived at by examining the inherent complexity of images. Accordingly, systems and methods are needed to advance the state of the art so as to provide video data that properly retains semantic information in the data, while reducing resolution or the available information content in such data below the lower bounds needed to perform tasks that would reveal PII of participants in the scene represented by data, e.g., facial recognition tasks.

### SUMMARY OF THE INVENTION

According to one embodiment, a system for the generation of a privacy-preserving embedding from an arbitrary source image comprises a plurality of convolutional blocks and a dense neural network layer. More specifically, the plurality of convolutional blocks receive the arbitrary source image for downsampling, the output from a first one of the plurality of convolutional blocks passed to a next one of the plurality of convolutional blocks. The dense neural network layer receives the output of the plurality of convolutional blocks, with the plurality of convolutional blocks and the dense neural network layer arranged as an encoder network. The encoder network receives the arbitrary source image and generates the privacy-preserving embedding as a sample from an information dense vector space with patterns that describe semantic information of the arbitrary source image.

A given one of the plurality of convolutional blocks may comprise a downsampling convolutional layer, a batch normalization layer, and a nonlinear activation function, which may further comprise a plurality of batch normalization layers given one of the plurality of batch normalization layers may normalize values across a current batch of data at the given batch normalization layer to provide a normalized data distribution to a next batch normalization layer subsequent to the given batch normalization layer.

A given one of the plurality of convolutional blocks may extract abstract semantic information from the arbitrary source image by learning to match areas in the arbitrary source image to a pattern. According to one embodiment, a given one of the plurality of convolutional blocks learns the pattern by convolving the pattern across the arbitrary source image. A given one of the plurality of convolutional blocks may convolve the pattern by calculating a dot product between the values of the arbitrary source image pixels and the components of the pattern. Alternatively, or in conjunction with the foregoing, a given one of the plurality of convolutional blocks convolves the pattern by downsampling in accordance with how far the pattern has strided across the arbitrary source image before outputting its similarity. The pattern may be learned in subsequent convolutional blocks and matched to lower order patterns found in previous convolutional blocks.

The nonlinear activation function introduced above may serve to prevent reconstruction of the arbitrary source image. In addition to the foregoing, embodiments of the present invention may comprise the dense neural network layer learning a linear transformation to transform the output of the plurality of convolutional blocks to the privacy-preserving embedding. The privacy-preserving embedding according to one embodiment is a 1×16 dimensional vector with a single floating point precision bit depth.

In addition to the encoder network, embodiments of the invention may comprise a dense decoding neural network layer and a plurality of convolutional transpose blocks. The output from a first one of the plurality of convolutional transpose blocks may be passed to a next one of the plurality of convolutional transpose blocks, the plurality of convolutional transpose blocks and the dense decoding neural network layer arranged as a decoder network that corresponds to the encoder network. The decoder network may receive the privacy-preserving embedding to generate a recovered image therefrom and is operative to pass updates to the encoder network via back propagation so as to reduce a reconstruction error of the decoder network.

A system for the generation of a privacy-preserving embedding from an arbitrary source image may further comprise one or more downstream models, a given downstream model operative to extract specific semantic information from the privacy-preserving embedding in the absence of any PII. Specific extracted semantic information may be selected from the set of specific semantic information consisting of a person count, a room classification, a cleanliness detection, and an aesthetic ranking.

### BRIEF DESCRIPTION OF THE DRAWINGS

Embodiments of the invention are illustrated in the figures of the accompanying drawings which are meant to be exemplary and not limiting, in which like references are intended to refer to like or corresponding parts, and in which:

FIG. 1 presents a block diagram illustrating an exemplary architecture for the transformation of a source image into a corresponding embedding in accordance with one embodiment of the present invention;

FIG. 2 presents a flow diagram illustrating an encoder generating embeddings by passing a source image through several convolutional blocks in accordance with one embodiment of the present invention;

FIG. 3 presents a block diagram illustrating the internal architecture of a convolutional block in accordance with one embodiment of the present invention;

FIG. 4 presents a block diagram illustrating an encoder network paired with a complimentary decoder network in accordance with one embodiment of the present invention;

FIG. 5 presents a block diagram illustrating convolutional transpose layers with filters that scale each element of the previous layer and are projected into a higher dimensional shape in accordance with one embodiment of the present invention;

FIG. 6 presents a block diagram illustrating components for the calculation of a loss function with respect to one or more parameters of the model using a backpropagation algorithm in accordance with one embodiment of the present invention;

FIG. 7 presents original images, in conjunction with corresponding reconstructed images and embeddings in accordance with one embodiment of the present invention;

FIG. 8 presents a block diagram illustrating an architecture for training one or more downstream models based on one or more input labeled embeddings in accordance with one embodiment of the present invention;

FIG. 9 presents a block diagram illustrating an architecture for training one or more downstream models through the use of weakly-supervised label generation in accordance with one embodiment of the present invention;

FIG. 10 presents a block diagram illustrating hardware and software components involved in downstream model processing flow in conjunction with upstream model processing flow in accordance with one embodiment of the present invention;

FIG. 11 presents a block diagram illustrating alternative system architecture for the generation of embeddings in accordance with one embodiment of the present invention;

FIG. 12 presents a graph illustrating the ability of the trained regressor to count individuals from the privacy-preserving embeddings in accordance with one embodiment of the present invention;

FIG. 13 presents a block diagram illustrating a privacy stress test in accordance with one embodiment of the present invention; and

FIG. 14 presents a block diagram illustrating a modular system supporting simultaneous ingestion of source images from several different VMS systems in conjunction with an arbitrary number of downstream machine learning models operative to consume output embeddings and perform corresponding predictions

### DETAILED DESCRIPTION OF EMBODIMENTS OF THE INVENTION

Embodiments of the present invention are directed towards systems and methods that allow for the performance of computer vision analysis on one or more source images while preventing the use of facial recognition and other privacy invasive technologies. A source image may be transformed into a derived representation that takes the form of, e.g., a low dimensional feature vector, which is referred to herein as an embedding.

A deep representation learning model, such as a convolutional autoencoder, may be used to maximize the information content of the embedding, which serves to maximize the accuracy of downstream models that provide for analysis of the data contained in any given embedding presented for review. Advantageously from a privacy perspective, the low-dimensionality of an embedding imposes a strict upper bound on the possible information contained therein, which is sufficiently small enough to prevent the use of facial recognition in downstream tasks.

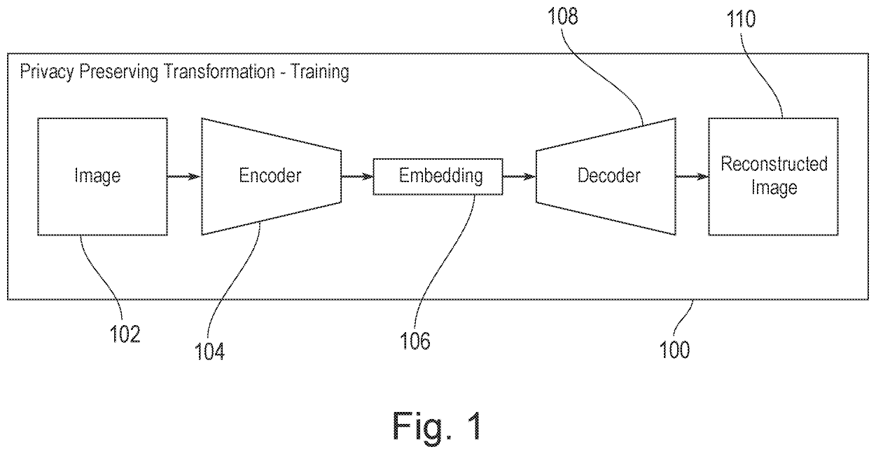

FIG. 1 presents a block diagram illustrating an exemplary architecture 100 for the transformation of a source image into a corresponding embedding. In accordance with the embodiment of FIG. 1, training of the privacy-preserving transformation model 104, labeled as the encoder, is unsupervised, meaning that no human viewing or labeling of the data is needed to train the transformation model. As indicated above, training is performed using a second neural network 108 called a decoder, which reconstructs images 102 from embeddings 106. During training, training source images 102 are passed through the encoder 104 and decoder 108 to form reconstructed images 110 whereby the differences between the reconstructed 110 and original images 102 are backpropagated through the networks 104 and 108 until the encoder 104 learns how to encode abstract semantic information into the embeddings 106. As such, the decoder 108 is only used during training the encoder 104 to encode an arbitrarily presented source image 102 for transformation into an embedding 106.

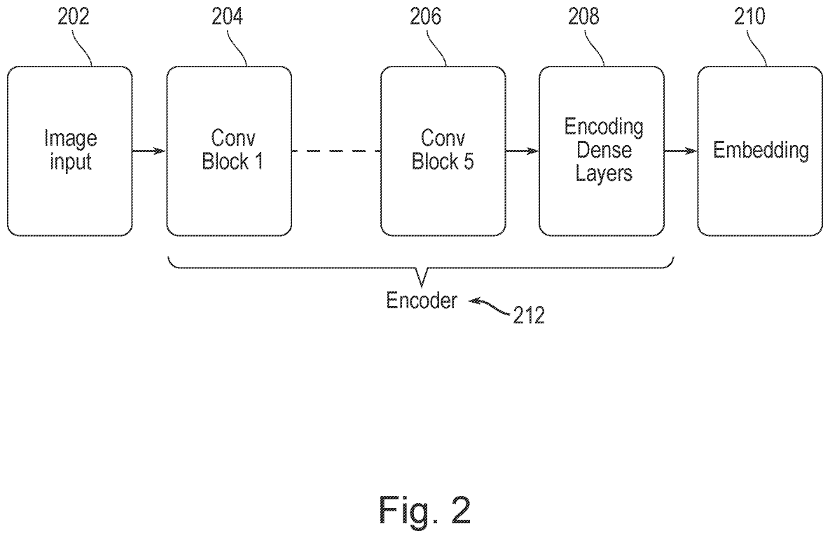

As indicated above, privacy-preserving embeddings 106 generated in accordance with embodiments of the present invention may be made through the use of a type of deep learning model referred to as a convolutional autoencoder, which consists of two deep neural networks referred to as an encoder 104 and a decoder 108. Focusing on the encoder, FIG. 2 illustrates that the encoder 212 may generate embeddings 210 by passing a source image 202 through several convolutional blocks, labeled convolutional blocks 1 (204) through 5 (206) in the exemplary architecture presented 212, and finally through a dense neural network layer 208.

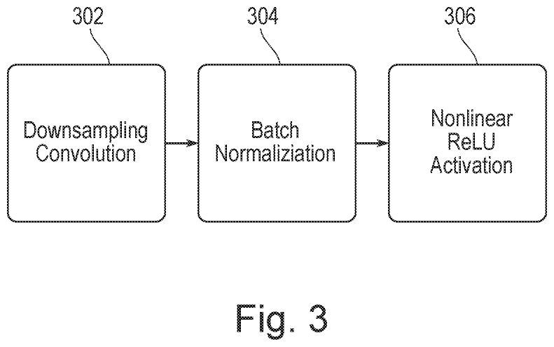

A given convolutional block 204, 206 as introduced according to the embodiment in FIG. 2 may consist of a downsampling convolutional layer, a batch normalization layer, and a nonlinear activation function, which may specifically implement a ReLU function. A diagram of a convolutional block is shown at FIG. 3.

Building on the architecture of FIG. 3, a convolutional layer 302 extracts abstract semantic information from an image by learning to match areas in the image to small patterns, referred to as filters. The patterns and the relative importance of each (referred to as weights) are not predefined but rather themselves learned by the model, which is described herein. The specific process by which these patterns are learned involves matching, which is accomplished by sliding, or convolving, the patterns or filters across the image. At a given position, a similarity between the pattern and the current portion of the image is measured by calculating the dot product between the values of the image pixels and the components of the filter. The current layer is also downsampled by adjusting how far each filter has strided across the image before Outputting its similarity.

By chaining convolutional layers together, patterns are not only matched to the original image, but also learned in subsequent convolutional layers and matched to the lower order patterns found in the previous convolutional layers. For example, a first convolutional layer can learn to recognize patterns in the original image, but a second convolutional layer can learn to recognize patterns in the configurations of patterns learned by the first convolutional layer. In this manner, as more convolutional layers are added to the model, more abstract information is abstracted from the original image. Additionally, as each convolutional layer is performing downsampling, for example, a 256×256×3 (width×height×colors) dimensional image can be downsampled to 32×32×64 (width×height×filters), for example, by applying a chain of five (5) convolutional layers.

Continuing with FIG. 3, the use of one or more hatch normalization layers 304 may be used to improve training performance by normalizing the values across a current batch of data at a then current layer. This provides a normalized data distribution to the next layer of computation. Finally, application of nonlinear activation functions 306 may allow the model to learn to approximate an arbitrary function, thereby allowing for a higher degree of flexibility and model expressiveness than purely linear layers. The use of nonlinear activation functions 306 also makes the model robust against inversions (reconstruction) occurring without the original model. The encoder may be terminated by a dense layer that learns a linear transformation to transform, for example, a 32×32×64 dimensional output of a final convolutional layer to an embedding, which may, e.g., comprise a 1×16 dimensional vector output.

According to one embodiment, a given privacy-preserving embedding comprises a vector with dimensions 1×16 and single floating point precision bit depth. This embodiment creates an upper bound on the information contained by the embeddings of 512 bits, which is less than the lower bound of information needed to support downstream facial recognition, as estimated above. It should be noted that a given embedding is typically on average expected to contain less information than the upper bound of 512 bits. Empirical estimation, for example using the Kozachenko-Leonenko estimator for differential entropy, indicates that embeddings comprise an average entropy of approximately 150 bits, which is far below the minimum amount of information required for use in downstream facial recognition tasks.

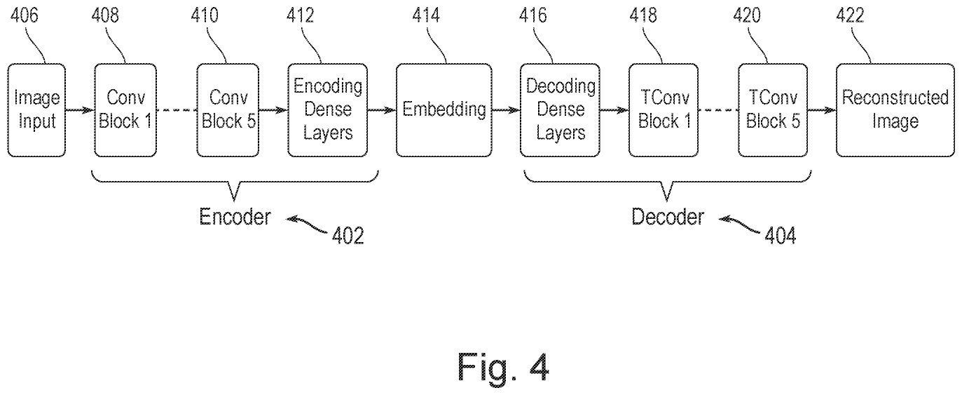

Training of the encoder to generate an output embedding is accomplished by pairing the encoder network with a complimentary decoder network, one embodiment of which is shown in FIG. 4. As illustrated by the embodiment of FIG. 4, the decoder 404 may comprise any arbitrary network that maps embeddings 414 to reconstructed images 422. In accordance with one implementation, a decoder 404 is used that comprises the inverse architecture of the encoder 402 that creates an embedding 414 from a corresponding input image 406.

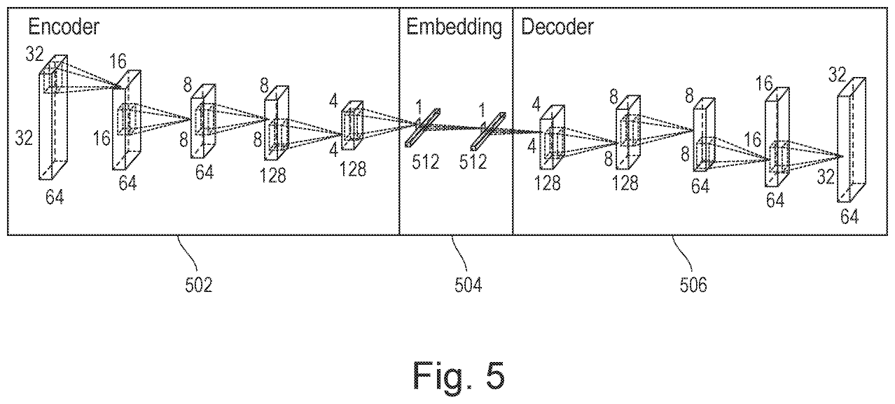

Continuing with the embodiment of FIG. 4, embeddings 414 are passed to the decoding dense layers 416 of the decoder 404, which may be comprised of a dense neural network layer and a nonlinear ReLU activation function. When utilized, this dense layer 416, which has a corresponding encoding dense layer 412, is operative to learn the optimal decoding from a 1×16 dimensional embeddings to the 32×32×64 input to the convolutional transpose blocks 418, 420 of the decoder 404. In accordance with embodiments of the invention, a convolutional transpose layer 418, 420 is similar to a convolutional layer 408, 410, except that in the case of the convolutional transpose layer 418, 420 the filters are scaled by each element of the previous layer and projected into a higher dimensional shape, which is illustrated in FIG. 5.

As shown by FIG. 5 similar to the manner in which the stride was adjusted to obtain downsampling in the convolutional case 502 to arrive at an embedding 504, adjusting the stride in the convolutional transpose layers 506 results in upsampling. Thus, after successive convolutional transpose layers 418, 420, the output of the decoding dense layer 416 may be upsampled from 32×32:64 to a reconstructed image 422, which in the present example is of size 256×256×3. In the present embodiment, unlike convolutional blocks 408, 410, convolutional transpose blocks 418, 420 do not necessarily perform batch normalization prior to evaluation or application of a nonlinear ReLU activation function.

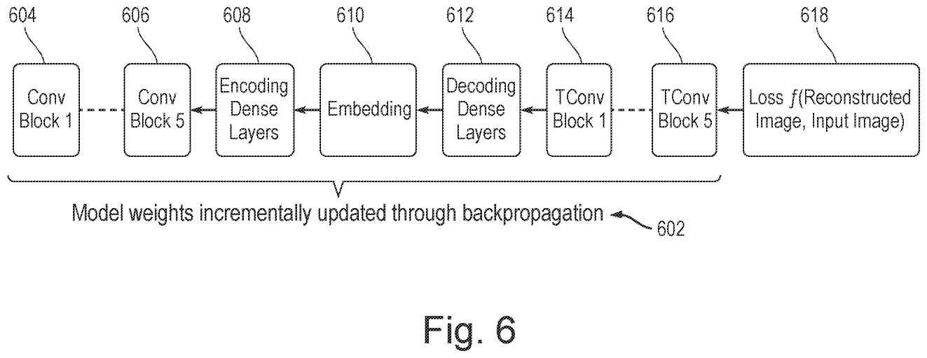

FIG. 6 illustrates components in accordance with one embodiment for the calculation of a loss function with respect to one or more parameters of the model using a backpropagation algorithm 602. The model parameters in accordance with the present embodiment are the weights and biases of the neural network's hidden neurons. This set of weights may encompass all of the parameters that affect the particular filters or patterns, as well as a relative importance for each, which may be encapsulated in the convolutional 604, 606 and convolutional transpose 614, 616 transformations. Likewise, additional weights may be used to parametrize the magnitudes of both the linear transformations of the dense layer 608 as employed by the encoder, as well as the nonlinear transformations of one or more of the ReLU activation functions. In one embodiment, the model has approximately four (4) million weights. The optimal values of these weights are learned during training in which the weights are first initialized with random numbers and then are updated using real data 602.

Training may be performed iteratively, for example, by taking a large training dataset (˜100 K) of sample images and passing them forward through the model as described above. For a given image, this results in an embedding 610 as well as a reconstructed image. As illustrated by FIG. 6, the autoencoder model, which in accordance with various embodiments refers to the combined process of simultaneously training an encoder 604, 606, 608 and decoder 612, 614, 616, learns by comparing the reconstructed image with the original image using a loss function 618. In one embodiment, the loss function 618 is calculated using the mean square error, but other loss functions can be used.

Weights may be updated 602 using mini-batch gradient descent, where for a subset (batch) of the images the first order derivative of the loss function with respect to each parameter of the model is calculated using the backpropagation algorithm. Weights may also or alternatively be adjusted 602 by incremental steps in the direction of the calculated derivatives, bringing them closer to their optimal value at each iteration. According to one embodiment, this procedure is done for all subsets or batches of the available data. One or more entire training passes (epochs) over the entire dataset are performed until the loss function no longer improves, at which point the final weights of the trained model are stored.

As the upstream model 604, 606, 608 is trained on training images, the decoder 612, 614, 616, learns how to reconstruct training images given the low-dimensional embeddings 610 produced as output by the encoder 604, 606, 608. In effecting this process, the encoder and decoder share no information except that which is passed from the encoder to decoder in the form of an embedding 610 and that which is passed from decoder to encoder via the backpropagation 602, allowing both encoder and decoder to modify their output so as to reduce the decoder's reconstruction error 618. The process by which the encoder and decoder are jointly modified 602 with regard to the reconstruction error is referred to herein as “learning” or “training”.

In accordance with the foregoing, the encoder 604, 606, 608 and decoder 612, 614, 616, must therefore learn how to best represent in any given embedding 610 both individual images that the decoder must reconstruct, as well as every image the encoder and decoder has encountered during training integrated via backpropagation 602. The encoder and decoder accomplish this representation by establishing patterns in the embedding vector space such that similar images appear as similar embeddings—that is, they have nearer Euclidean distances in the embedding vector space—and information about any single vector can be inferred given known or “labelled” information about a similar or nearby vector.

The informational stricture on a given embedding 610 allows for embeddings 610 produced by the encoder 604, 606, 608 to be a sample from an information dense vector space containing patterns describing semantic information of the original image, as well as semantic information with respect to the population of embeddings generated by a given instance of an encoder. The upper informational bound on a given embedding 610 guarantees that any individual vector in this space cannot carry information that constitutes PII.

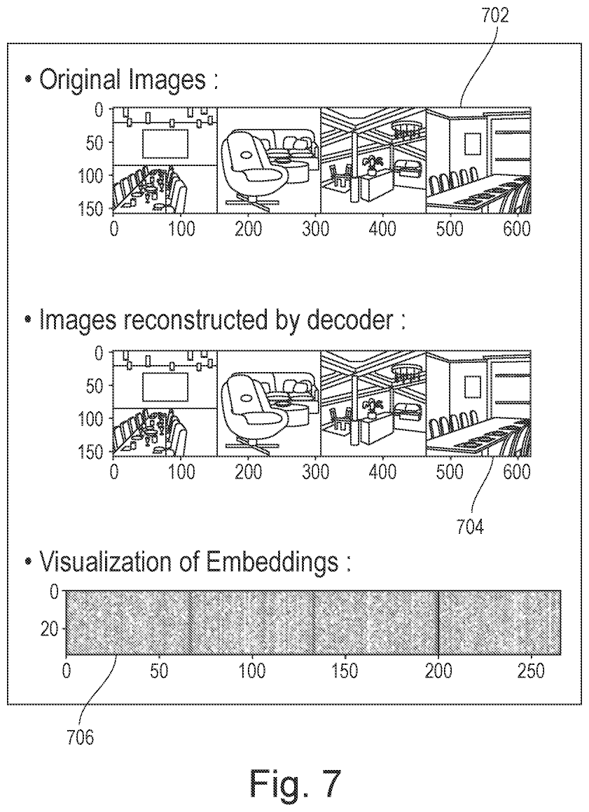

According to certain embodiments, the encoder may learn an optimal set of model parameters during training needed to encode the maximum amount of semantic information into the lower dimensional embeddings. As shown in FIG. 7, the autoencoder may accomplish its machine learning task by encoding training images 702 into lower dimensional embeddings 706, Which are then reconstructed into the original training images 704 by the decoder. The losses, or differences between the original 702 and reconstructed images 704, are then backpropagated through all of the parameters of the model. Training proceeds until a set of parameters is learnt, which encodes the optimal amount of information in the resultant embeddings 706.

As can be seen in the last panel of FIG. 7, the embeddings 706 output by the autoencoder model contain no visual information that could be used in the reconstitution of PII contained in the original source images 702 and, as a result, cannot be used to identify individuals. Indeed, such embeddings 706 no longer contain any discernible visual information whatsoever. After properly training the encoder model, the decoder is no longer needed, and embeddings 706 can be generated from arbitrary images by passing them forward through the encoder.

It is imperative that the parameters of the encoder model are secured to the same degree as the original images themselves. As discussed above, during the training phase, the encoder learns an optimal set of parameters or weights by reconstructing training images from their embeddings. Therefore, it is possible to reconstruct images from the embeddings, but only with the exact decoder parameters learned during training. Since the exact values of these parameters depend on the model architecture, model hyper-parameters exact training images, and random initialization noise, it is infeasible that an adversary could decode a source image from its corresponding embedding without knowledge of these parameters.

Embeddings are advantageous for use by downstream models, because of the above—described process through which a given embedding may be encoded. In accordance with embodiments in which 1×16 dimensional embeddings are used, the model may assign each image a point in a sixteen (16) dimensional vector space. The model encodes semantic information from the image by assigning semantically similar images to regions of the vector space that are closer in Euclidean distance. Downstream machine learning models can thus make inferences about the original image by only referencing a corresponding embedding, e.g., by analyzing the location of the embedding in the sixteen (16) dimensional embedding vector space. For example, images containing a similar number of individuals will be assigned points in the vector space clustered near each other.

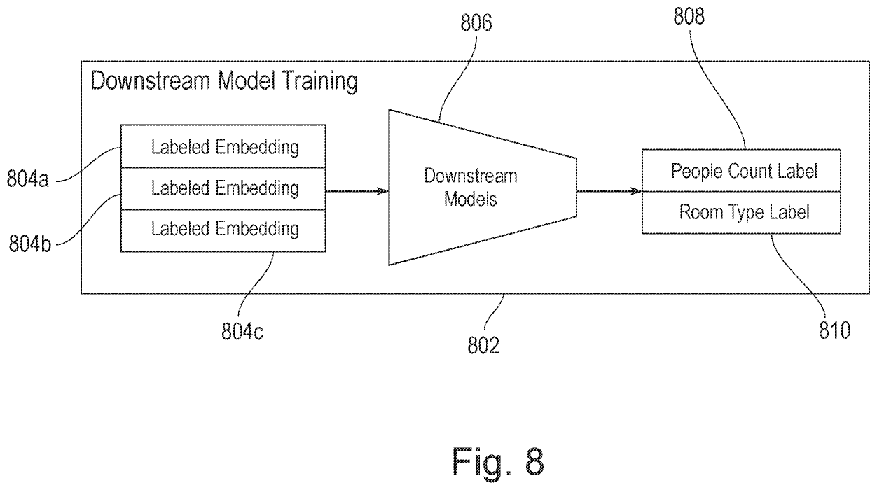

Turning to FIG. 8, downstream models 806 constitute any class of any machine learning model that can exploit patterns in arbitrary vector-spaces for the purpose of prediction, inference, analysis, etc. Members of the class downstream models only need to share a single quality: that they consume the output of the upstream model, e.g., the privacy-preserving embedding, to perform prediction, inference, analysis, etc. in the absence of the original or any training images. To this end, downstream models 806 may be created to serve practically any purpose that may be desired by an entity or organization deploying the encoder to process source images for the removal or obfuscation of PII while preserving semantic details.

Downstream models 806 must first be trained 802 prior to being able to perform predictions when presented with an embedding. In accordance with one embodiment, labeled embeddings 804a, 804b, 804c are provided to one or more downstream models 806 for training, e.g., people counts, item counts, room occupancy, resource consumption, etc. This can be accomplished by supervised training in which a training set of embeddings are labeled by human editors 804a, 804b, 804_{c} with metadata targeted to the metric under consideration, e.g., when training a downstream model 806 to perform counts of individuals when presented with an embedding, a training set of embeddings 804a, 804b, 804c may be labeled by humans with the number of individuals contained in the source image.

Because embeddings generated in accordance with embodiments of the present invention are based on an informationally dense vector space description, a given downstream model 806 may comprise any process that can “learn” or be trained to exploit information encoded in some vector space without ever needing to know how such vector space could be reconstructed as an image. Additionally, without prior knowledge of the images used to form a given embedding, no downstream model 806 may obtain sufficient information necessary to reconstruct the image unless that downstream model was precisely the specific decoder present in the upstream model.

Any given downstream model 806 may be understood as comprising any arbitrary algorithm operative to perform prediction, inference, analysis, etc. on an information dense vector space by exploiting patterns. As described above, the output of the encoder from the upstream model creates an informationally dense vector space representation of any source image in the form of an embedding. According to one embodiment, the set of embeddings created by a single deployment or instance of the encoder represents a set of “samples” that may—or may not—completely describe the informationally dense vector space; as that set of vectors approaches infinity, the sampling of the vector space may also approach completeness.

In view of the foregoing, a given downstream model may consume an arbitrary embedding to exploit patterns found across the set of embeddings on which the downstream model 806 “learns” with or is “trained”. In this way, these downstream models 806 may be trained to extract specific semantic information 808, 810 regarding any individual embedding 804a, 804b, 804c, with any specific inference limited by the total amount of information any embedding 804a, 804b, 804c may contain, which, in accordance with the systems and methods presented in connection with embodiments of the present invention are preserving privacy by design.

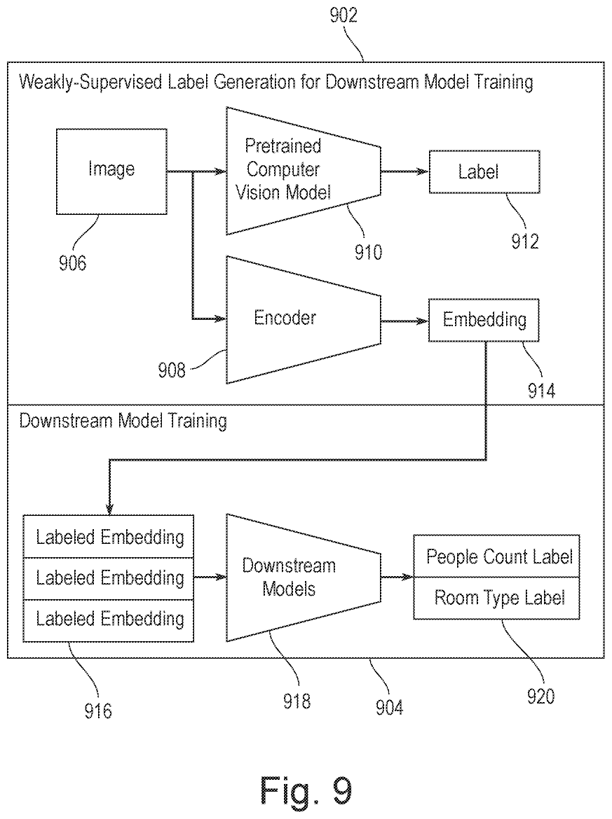

In addition to supervised learning, downstream models may be trained through the use of weakly-supervised label generation, one embodiment of an architecture for which is illustrated at FIG. 9. In accordance with one embodiment of an architecture and technique for weakly-supervised label generation for downstream model training 902, labels 912 are created for a small set of training images 906 through the use of end-to-end pretrained computer vision models 910. The output of the encoder 908 is a series of labeled embeddings 916 that correspond to a set of source images 906. Downstream models 918 are trained on the labeled embeddings 914 and, as such, are never exposed to source images 906, even in training.

Specific implementations of downstream models 918 and their relation to the above description of the general requirements for any downstream model are provided below.

People Counting from Embeddings—Given a labeled dataset 916 specifying only the count of individuals present in each image and the embeddings formed from each image, the downstream model 918 may be implemented as a gradient boosted tree model that is trained to produce 920 the number of individuals present given the embedding formed from the source image.

With a sufficient number of training examples, the downstream model may learn 904 how to determine an estimated number of individuals in the unseen image given only the embedding. This allows the downstream model to produce count estimates on individuals present in new embeddings, as well as use standard machine learning supervised model validation techniques to estimate confidence in those estimates given a labeled training data set containing only embeddings and the count of individuals in the original image.

Room Classification from Embeddings—Given a labeled dataset 916 specifying only the type of room each CCTV camera is situated in and the embeddings produced by each CCTV camera (‘type’ may refer to an arbitrary set of room designations including, but not limited to, ‘Common Area’, ‘Conference Room’, ‘Elevators’, ‘Entrance/Exit’, ‘Hallway’, ‘Office Space’, ‘Outside’, ‘Server Room’, ‘Small Common Area’, ‘Storage’, or ‘Faulty Camera Installation’), the downstream model 918 may be implemented as a gradient boosted tree model trained to produce 920 the “type” of room in which the camera is situated, given only the embeddings created by that camera.

With a sufficient number of training examples, the downstream model may learn how to arrive at the estimated room type in the unseen image given only the embedding. This allows the downstream model to estimate the type of room in which the camera is situated upon the receipt of new embeddings, as well as use standard machine learning supervised model validation techniques to estimate confidence in those estimates given a labeled training data set containing only embeddings and a label indicating the ‘type’ of room in which the camera responsible for the image and resulting embedding is situated.

Cleanliness Detection from Embeddings—Given a labeled dataset 916 specifying only whether there is some ‘mess’ present in the original image and the associated embeddings, the downstream model 918 may be implemented as gradient boosted tree model trained to produce 920 the probability that there may be a ‘mess’ in the space observed by the CCTV camera given only the embeddings representing that space.

With a sufficient number of training examples, the downstream model may learn how to arrive at the probability of there being a ‘mess’ in the unseen image given only the embedding. This allows the downstream model to estimate the presence of a ‘mess’ in a space overseen by a CCTV camera, as well as use standard machine learning supervised model validation techniques to estimate confidence in those estimates given a labeled training data set containing only embeddings and a label indicating whether a ‘mess’ is present in the unseen image.

Aesthetic Ranking from Embeddings—Given a labeled dataset 916 specifying only the ‘aesthetic score’ of the original image and the associated embeddings, the downstream model 918 may be implemented as gradient boosted tree model trained to produce 920 the ‘aesthetic score’ of the original image given only the embeddings corresponding to the image.

With a sufficient number of training examples, the downstream model may learn how to arrive at the aesthetic score of the unseen image given only the corresponding embedding. This allows the downstream model to estimate the present aesthetic qualities of the space pictured in the unseen image, as well as use standard machine learning supervised model validation techniques to estimate confidence in those estimates given a labeled training data set containing only embeddings and a label indicating the ‘aesthetic score’ for the unseen image.

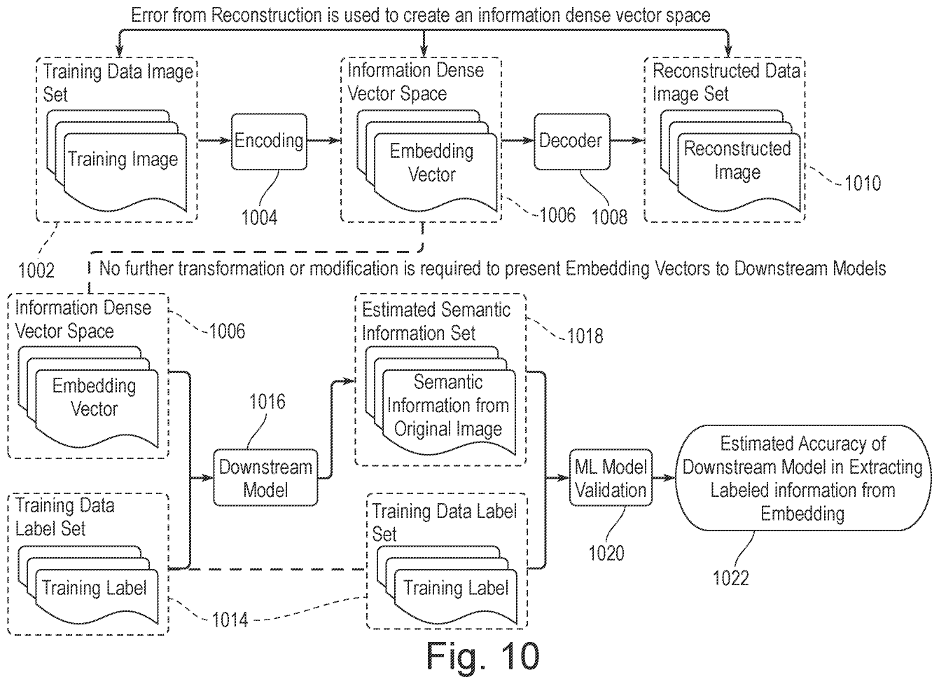

One embodiment of hardware and software components involved in downstream model processing flow in conjunction with upstream model processing flow is presented below in FIG. 10. According to the embodiment of FIG. 10, processing begins with receipt by the encoder 1004 with one or more training images 1002, the processing of which results in the generation of one or more corresponding embeddings 1006, which reside in an information dense vector space. A decoder 1008 receives one or more of the resultant embeddings 1006 to produce a set of one or more corresponding reconstructed images 1010. Error correction from reconstruction of the reconstructed images 1010 by the decoder 1008 on the basis of the one or more corresponding embeddings 1006 is backpropagated as part of the creation of the information dense vector space.

No further transformation or modification is required to present a given embedding to a downstream model. As such, a downstream model 1016 receives a given embedding 1006 and a corresponding training label 1014 as input. A given downstream model 1016 uses the embedding 1006 and corresponding training label 1014 to generate resultant data 1018, referred to as an estimated semantic information set, which comprises semantic information from the original image 1002. An ML model validation process 1020 receives that semantic information 1018 from the original image that the downstream model generates in conjunction with the corresponding training label 1014 to generate an estimated accuracy 1022 of the downstream model in extracting labeled information from a given embedding.

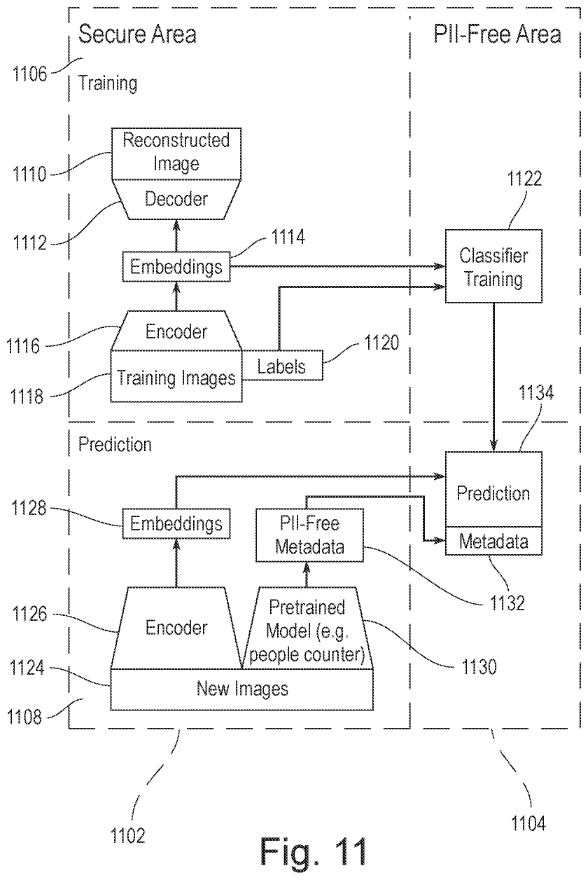

In addition to the embodiment of processes and components involved in downstream model processing flow in conjunction with upstream model processing flow set forth in FIG. 10, FIG. 11 illustrates a block diagram presenting one embodiment of an alternative system architecture for the generation of embeddings, which may be used in conjunction with other embodiments as described herein. In accordance with the architecture of FIG. 11, computing components and processes are deployed in a first, secure area 1102 and a second, insecure area 1104 in which no PII is made available. Furthermore, as shown, both the secure area 1102 and the insecure area 1104 are further divided into a training area 1106, where models are trained, and a prediction area 1108 where are applied, as described in further detail herein.

A convolutional encoder model 1116 is trained to generate embeddings 1114 on the basis of a set of training images 1118. The untrained convolutional encoder model 1116 presented by FIG. 11 may reside in the same secure area 1106 as the unsecured training images 1118, which contain PII, whereby the encoder-decoder pair 1116, 1112 trained on a subset of these images. Alternatively, the images may be hosted remotely and provided to the encoder 1116 over a secure connection. Regardless of the ingestion source, the training images 1118 may remain secure in rest and transit to maintain the integrity of any PIT contained therein.

The encoder-decoder pair 1116, 1112 reconstruct 1110 the training images 1118 from the embeddings to properly train the encoder 1116. Once properly trained, embeddings 1114 and corresponding labels 1120 may be provided to one or more downstream models 1122 to train such models as to the prediction or determination of semantic information contained in a given embedding 1114. It should be noted that a downstream model may be hosted in the insecure area. 1104 as neither the embeddings nor the labels contain information that would be of any value to an attacker or other adversary which is explained in greater detail herein.

Once trained, the encoder 1126 can be deployed to the secure 1102 prediction area. 1108 and used to encode embeddings 1128 from new images 1124 that contain PII. Corresponding labels 1132 are provided with a given embedding 1128, such corresponding label 1132 providing PII-free metadata, which may encode semantic information with respect to a corresponding embedding 1128. According to one embodiment, labels are generated by another machine learning subprocess 1130, which is trained to identify and record specific items of semantic information in a given image 1124, e.g., people counter, trash estimator, item counter, etc.

An embedding 1128 and its corresponding label 1132 do not contain any PE Accordingly, they may be transferred to an insecure area 1104 that is not necessarily subject to the same technical and organizational safeguards that would apply to a system storing PII in the secure area 1102, such as an internal corporate storage cloud or data warehouse. Once embeddings 1128 and corresponding labels 1132 move to the insecure area 1104, the embeddings 1128 and labels 1132 may be used for downstream business machine learning tasks 1134, which may be based on the training of one or more classifier models 1122 that may learn to identify semantic information contained in the source image 1124 from analysis of a corresponding embedding 1128. Downstream models 1134 may process embeddings 1128 in conjunction with metadata 1132 to extract specific semantic information from a given embedding 1128 in the absence of any PII.

The performance of these exemplary embodiments on downstream tasks was tested with 10K images: 8K images were used to train the convolutional encoder and the remaining 2K images were labeled with the number of individuals in the image, as well as a tag as to whether or not the image was of a common area. The images were then encoded into privacy-preserving embeddings. These embeddings, along with their labels were next randomly split: 80% training set and a 20% test set. For the performance test, a gradient boosted tree regressor was trained to count individuals on the basis of the embeddings, without any reference to the original images, in conjunction with labels that, in the present embodiment, which may be derived from the source images, e.g., the models are trained with label-embedding groups, but perform predictions solely with embeddings.

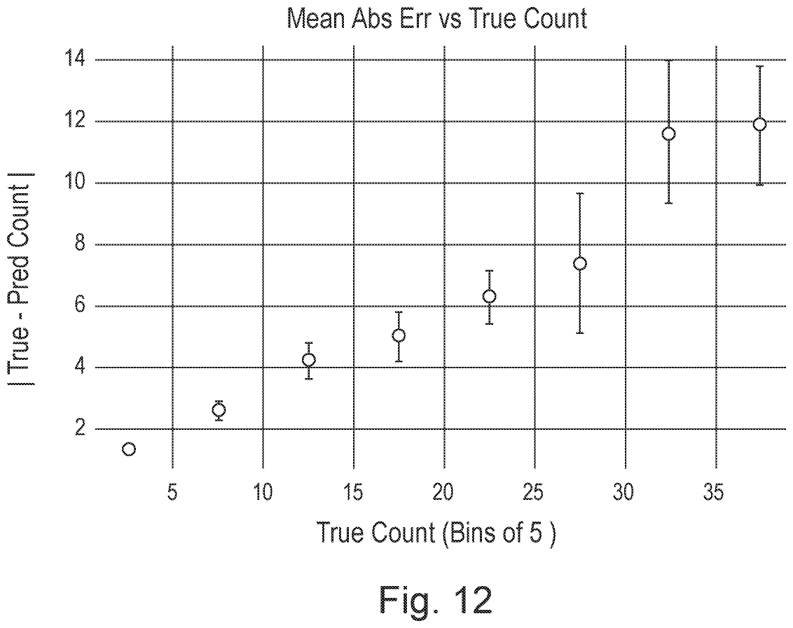

The ability of the trained downstream model to count individuals from the privacy-preserving embeddings is shown in FIG. 12. For images containing less than five (5) individuals, the downstream model obtains an accuracy of ±˜1.5 individuals and for images containing up to twenty (20) individuals the model obtains an accuracy of ±˜5 individuals. Similarly, using the same embeddings and, again, without reference to the original images, a gradient boosted tree classifier may be trained to detect whether an embedding originated from an image of a common space. This classifier obtained an F1 score of 86.7%.

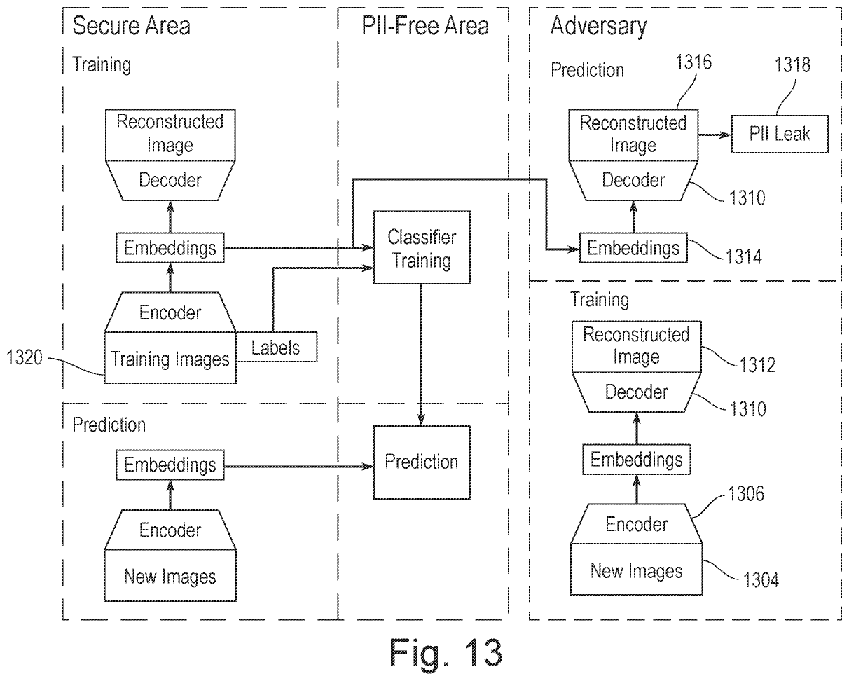

To prove the privacy-preserving nature of the embeddings, a privacy stress test may be constructed for execution in accordance with the embodiment of FIG. 13. The stress test of FIG. 13 plays out a scenario whereby an adversary has knowledge of the deep learning architecture used and described herein, has gained access to the embeddings, as well as has access to similar images used during training. It was evaluated if such an adversary could train his or her own encoder 1306, using the decoder 1310 from their model to reconstruct 1316 a source images 1320 from its corresponding embedding 1314.

To evaluate this scenario a second “adversary” convolutional encoder 1306 was trained with similar, but differing images 1304 using the same deep learning architecture. Even with the same deep learning architecture and similar training images, as long as the adversary does not have access to the secure parameters (weights), such party cannot reconstruct 1316 the original images 1320 from an embedding 1314, instead only generating noise 1318. This is due to the fact that without the original parameters, the adversary model performs completely different nonlinear transformations to the embeddings 1314 and is therefore unable to reconstruct the original image 1320 or any PII contained therein.

In accordance with various embodiments, which include the deployment of hardware and software components described herein, e.g., an upstream model and downstream model(s), may follow the procedure described below so as to ensure source images that may contain PII are not stored to unencrypted disk or displayed to human viewers. For example, assume images that are pulled from a source location may be placed in a message queue for a maximum time window, e.g., one hour. During this time,
a given image may reside in memory and is not written to disk;
images may reside momentarily in memory inside an ephemeral microservice that ingests video data; and
images may reside in memory inside the ephemeral microservice that maintains the message queue for a maximum time period.

Pulled images may be transformed into the derived privacy-preserved data set, e.g., one or more embeddings created in accordance with the system and methods described and disclosed herein. During this time,
images may reside in memory only; and
images may reside momentarily in memory inside the ephemeral microservice that performs the privacy-preserving transformation.

These derived embeddings may be analyzed by one or more downstream machine learning models, which may be used for any variety of business purposes so long as the downstream models are properly configured to consume embeddings for further analysis. These downstream models do not have access to the original images.

The derived dataset, which may comprise one or more embeddings, and the outputs of the downstream machine learning models described herein, may be stored indefinitely in a data warehouse or other data structure for the long term storage of data. Given this architecture, processing can take place without persistently writing or storing any original images to disk. Accordingly, at no time does a downstream machine learning model analyze the original images, with the exception of training the encoder and decoder models used for the privacy-preserving transformation described herein.

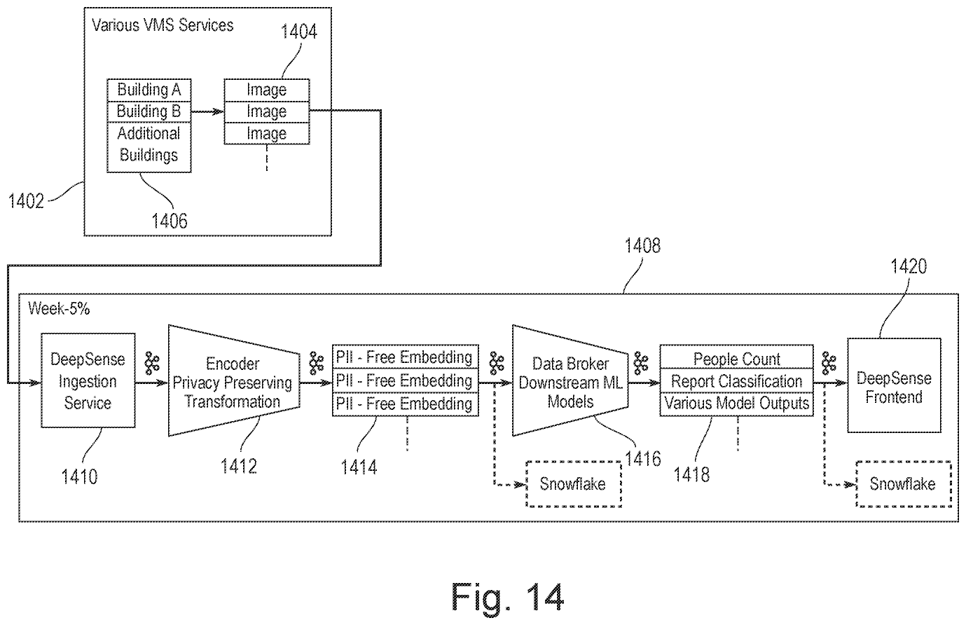

One embodiment of the above-described architecture is illustrated at FIG. 14, which illustrates a modular system supporting simultaneous ingestion of source images 1404 from several different VMS systems 1406 used by a physical security team 1402, as well as a processing pipeline 1408 for an arbitrary number of downstream machine learning models 1418 operative to consume output embeddings 1414 and perform corresponding predictions.

As part of the process of creating PII-free embeddings 1414 for further processing by one or more downstream models 1418, an ingestion service 1410 is operative to retrieve or otherwise access the source images 1404 from the several different VMS systems 1406. These one or more source images 1404 are provided as input to an encoder 1412 that transforms a given source image 1404 into a corresponding embedding 1414, which comprises the removal or obfuscation of all PII from a source image while preserving the semantic information contained therein. A data broker 1416 distributes a given one of the one or more PII-free embeddings 1414 to a respective downstream model 1418 to qualify and quantify the semantic information from the original image 1404 as preserved by the corresponding PII-free embedding 1414.

Operators and information consumers, which may be humans or other software processes, indirectly interface with the embeddings via the semantic information 1418 contained therein by way of a client application or process 1420. According to one embodiment, the client application 1420 is a desktop or mobile application that provides UI/UX functionality to accesses a data store containing semantic information 1418 from source images 1404 taken in a specific location 1406, e.g., as exposed by a given downstream model 1418. As such, human operators or other downstream software processes may obtain semantic information regarding a location, e.g., was the room occupied?, how many individuals were in the room at a specific time?, how clean was the room?. On the basis of this information, which may be in conjunction with other information, human operators or other downstream software processes may react or otherwise engage in the execution of additional decision-making processes.

FIGS. 1 through 14 are conceptual illustrations allowing for an explanation of the present invention. Those of skill in the art should understand that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine-readable medium as part of a computer program product and loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but rather should be defined only in accordance with the following claims and their equivalents.

What is claimed is:

1. A system for the generation of a privacy-preserving embedding from an arbitrary source image, the system comprising:
a plurality of convolutional blocks that receive the arbitrary source image for downsampling, the output from a first one of the plurality of convolutional blocks passed to a next one of the plurality of convolutional blocks; and
a dense neural network layer to receive the output of the plurality of convolutional blocks, the plurality of convolutional blocks and the dense neural network layer arranged as an encoder network, wherein the encoder network receives the arbitrary source image and generates the privacy-preserving embedding as a sample from an information dense vector space with patterns that describe semantic information of the arbitrary source image.

2. The system of claim 1 wherein a given one of the plurality of convolutional blocks comprises a downsampling convolutional layer, a batch normalization layer, and a nonlinear activation function.

3. The system of claim 1 wherein a given one of the plurality of convolutional blocks extracts abstract semantic information from the arbitrary source image by learning to match areas in the arbitrary source image to a pattern.

4. The system of claim 3 wherein a given one of the plurality of convolutional blocks learns the pattern by convolving the pattern across the arbitrary source image.

5. The system of claim 4 wherein the given one of the plurality of convolutional blocks convolves the pattern by calculating a dot product between the values of the arbitrary source image pixels and the components of the pattern.

6. The system of claim 4 wherein the given one of the plurality of convolutional blocks convolves the pattern by downsampling in accordance with how far the pattern has strided across the arbitrary source image before outputting its similarity.

7. The system of claim 3 wherein the pattern is learned in subsequent convolutional blocks and matched to lower order patterns found in previous convolutional blocks.

8. The system of claim 2 comprising a plurality of batch normalization layers.

9. The system of claim 8 wherein a given one of the plurality of batch normalization layers normalizes values across a current batch of data at the given batch normalization layer to provide a normalized data distribution to a next batch normalization layer subsequent to the given batch normalization layer.

10. The system of claim 2 wherein the nonlinear activation function prevents reconstruction of the arbitrary source image.

11. The system of claim 1 wherein the dense neural network layer learns a linear transformation to transform the output of the plurality of convolutional blocks to the privacy-preserving embedding.

12. The system of claim 1 wherein the privacy-preserving embedding is a 1×16 dimensional vector and a single floating point precision bit depth.

13. The system of claim 1 comprising:
a dense decoding neural network layer; and
a plurality of convolutional transpose blocks wherein the output from a first one of the plurality of convolutional transpose blocks is passed to a next one of the plurality of convolutional transpose blocks, the plurality of convolutional transpose blocks and the dense decoding neural network layer being arranged as a decoder network that corresponds to the encoder network, wherein the decoder network receives the privacy-preserving embedding to generate a recovered image therefrom.

14. The system of claim 13 wherein the decoder network passes updates to the encoder network via back propagation so as to reduce a reconstruction error of the decoder network.

15. The system of claim 1 comprising one or more downstream models, a given downstream model operative to extract specific semantic information from the privacy-preserving embedding in the absence of any PII.

16. The system of claim 15 wherein the specific semantic information is selected from the set of specific semantic information consisting of a person count, a room classification, a cleanliness detection, and an aesthetic ranking.
